(19) United States
(12) Patent Application Publication
(10) Pub. No.: US 2018/0093868 A1
(43) Pub. Date: Apr. 5, 2018

(54) ANTI-SWAY CRANE CONTROL METHOD WITH A THIRD-ORDER FILTER

(71) Applicant: MANITOWOC CRANE GROUP FRANCE, Dardilly (FR)

(72) Inventors: Xavier Claeys, Lyon (FR); Silvère Bonnabel, Boulogne Billancourt (FR)

(21) Appl. No.: 15/711,660

(22) Filed: Sep. 21, 2017

(30) Foreign Application Priority Data
Oct. 5, 2016 (FR) 16/59607

(51) Int. Cl. B66C 13/06

(52) U.S. Cl. CPC B66C 13/063; B66C 23/16

(57) ABSTRACT

A method for controlling displacement of a load suspended to a point of attachment of a lifting machine includes an acquisition step during which a piloting setpoint is acquired and which is representative of the displacement speed that the operator wishes to confer on the suspended load, a processing step during which a setpoint called execution setpoint, which is applied to a drive motor in order to displace the suspended load, is elaborated from the piloting setpoint, the processing step including a C³ smoothing substep by third-order filtering during which a third-order filter is applied to the piloting setpoint in order to generate a filtered piloting setpoint of smoothness class C³, and the execution setpoint is defined from the filtered piloting setpoint.

### CROSS-REFERENCE TO RELATED APPLICATION

This application claims priority under 35 U.S.C. §119(a) to French Patent Application No. 16/59607, filed on Oct. 5, 2016, the disclosure of which is incorporated by reference herein in its entirety.

### FIELD

The subject matte described herein relates to the general field of lifting machines, such as cranes, and more particularly to tower cranes, which include a movable point of attachment, such as a trolley, to which can be suspended a load to displace, called “suspended load”, and which are equipped with a piloting system allowing the moving and the control of the displacement of said suspended load.

More particularly, the subject matter described herein relates to the control methods intended to manage the piloting system of such lifting machines.

### BACKGROUND

In general, control methods for managing a piloting system, which are intended to provide an assistance in the piloting of the machine, comprise a step of acquiring a piloting setpoint, during which the speed setpoint which is expressed by the operator of the lifting machine is collected and which corresponds to the speed that said operator wishes to confer to the suspended load, then a processing step during which, an execution setpoint which is applied to the drive motor(s) which allow displacing said suspended load is elaborated, from said piloting setpoint.

Furthermore, in order to ensure the accuracy and the safety of the transport operations of the suspended load, the known control methods generally seek to control and more particularly to limit, the magnitude of the pendular oscillations, or sway, to which the suspended load may be subjected during the movements of the trolley.

To this end, it is known in particular to tackle the sway by a closed-loop servo-control, in which are measured the real values of the position and of the speed of the trolley, as well as the value of the angle of the sway of the load, in order to be able to generate a correction of the setpoint which is applied to the motors which actuate the trolley and which aims to reduce said sway.

While such a system actually allows attenuating the sway, it may nonetheless have some drawbacks.

Indeed, such a closed-loop servo-control imposes the implementation of numerous sensors, intended for example to measure the real angle of the sway, which increases the complexity, and consequently the cost, as well as the risk of failure, of the piloting system, and more generally of the lifting machine equipped with said piloting system.

Furthermore, the complexity of the mathematical model used by such a piloting system, as well as the amount of data to measure and process, tend to mobilize relatively considerable and costly resources in terms of computing power, memory and energy.

Moreover, the piloting assistance accordingly offered may have tendency to excessively dampen the responses (reactions) of the lifting machine to the orders of the operator (i.e., the crane operator or driver), thereby distorting the intuitive perception of the behavior of the machine that said operator may have, and in particular while giving said operator the unpleasant feeling that the machine lacks reactivity and does not faithfully execute his orders.

### SUMMARY

Consequently, the objects assigned to the subject matter described herein aim to overcome the aforementioned drawbacks and to propose a new method for controlling the displacement of a suspended load which provides a displacement of the suspended load which is both rapid and soft, with an effective mastering of the sway, which provides the operator with a faithful feel enabling a very free, reactive and relatively intuitive piloting, and which, despite these performances, is relatively simple and efficient to implement.

The objects assigned to the subject matter described herein are achieved by means of a method for controlling the displacement of a load suspended to a point of attachment of a lifting machine, said method comprising a piloting setpoint acquisition step (a), during which a setpoint, called the “piloting setpoint”, is acquired and which is representative of a displacement speed that the operator of the lifting machine wishes to confer on the suspended load, then a processing step (b) during which a setpoint, called the “execution setpoint”, which is intended to be applied to at least one drive motor in order to displace the suspended load is elaborated, from said piloting setpoint, the method being characterized in that the processing step (b) includes a C³ smoothing substep (b4) during which the piloting setpoint is processed so as to confer to said piloting setpoint properties of third differentiability with respect to time and continuity with respect to time, in order to generate, from said piloting setpoint, a setpoint, called the “filtered piloting setpoint”, which is of class C³, then the execution setpoint is defined from said filtered piloting setpoint.

More preferably, the C³ smoothing sub step (b4) may consist of a third-order filtering substep (a4) during which a third-order filter is applied to the piloting setpoint in order to generate a filtered piloting setpoint which is class C³.

By being of class C³, it is indicated, in the mathematical sense, that the considered parameter, herein the filtered piloting setpoint, or more specifically the function which represents the evolution of said considered parameter over time, that is to say the function representing the evolution of the filtered piloting setpoint over time, is three times differentiable with respect to time, and that said function, as well as its first, second and third time derivatives are continuous.

Advantageously, the C³ smoothing of the piloting setpoint (speed setpoint for the suspended load), and more particularly the use of a third-order filter applied to said piloting setpoint for this purpose, allows ensuring that the filtered piloting setpoint, which will be actually used afterwards to define the execution setpoint applied to the drive motor, is of class C³.

Advantageously, a filtered piloting setpoint, accordingly C³ smoothed, presents exceptional smoothness conditions (as it is herein three times differentiable, and since its first, second and third time derivatives are continuous), and consequently continuity and bounding mathematical properties that the raw piloting setpoint does not have in general, as defined and modified in real-time by the operator of the machine.

Indeed, it will be recalled that the operator of the machine can make the piloting setpoint vary at any time, in an unpredictable manner.

Depending on the different situations to which said operator of the machine must react, the piloting setpoint (which is herein in the form of a speed setpoint for the suspended load) can therefore vary on the one hand in sign, when the operator of the machine decides to change the direction of the movement (left/right, away/close), and on the other hand in magnitude (intensity), when the operator switches from a movement that he wishes to be rapid to a slower movement (deceleration), or conversely (acceleration).

Furthermore, the speed of these changes of the piloting setpoint may significantly vary, depending on the frequency and on the rapidity by which the operator of the machine actuates the controls to operate changes or corrections of the trajectory.

Hence, in practice, the raw piloting setpoint may present some step-type abrupt variations, which may be assimilated mathematically to discontinuities.

Similarly, in particular because of these discontinuities, the time derivatives (typically the first-order and the second-order derivatives) of the piloting setpoint, which will preferably be used in the modelling of the behavior of the suspended load and in the elaboration of the execution setpoint, may punctually present, if they have been calculated directly, without any appropriate smoothing (filtering), some divergences or some discontinuities, such that the resulting execution setpoint would be able to cause jerky or unstable reactions of the suspended load.

This is why the method according to the embodiments described herein advantageously smooths the piloting setpoint before said piloting setpoint is actually applied to the drive motor(s), which allows eliminating from the control signal (execution setpoint) the instabilities, discontinuities and other divergences which would be able to cause jerks and the occurrence (or the sustainment) of a sway.

Thus, it is possible to obtain a movement of the suspended load which is particularly regular and stable, regardless of the nature of said movement (that is to say regardless of the shape of the trajectory desired by the operator of the machine), and regardless of the speed and of the magnitude of said movements desired by the operator of the machine.

Advantageously, and as detailed hereinafter, the C³ smoothness conferred to the piloting setpoint further allows defining the execution setpoint subsequently, from said piloting setpoint, by means of a simplified mathematical model which is not only simple and rapid to execute, but which also, and especially, produces an execution setpoint which generates no sways intrinsically, that is to say an execution setpoint which, when applied to the actuating motors, does not cause (cannot cause by itself) the occurrence of a sway.

Moreover, the method according to the subject matter described herein allows in particular a free and accurate setting of the coefficients, as well as of the pulsation, of the third-order filter which is applied to the piloting setpoint, which allows preserving at every circumstance a rapid convergence of the speed of the suspended load towards the speed setpoint expressed by the operator of the machine.

In other words, the method provides a dynamic and reactive piloting.

Afterwards, the method according to the subject matter described herein advantageously allows optimizing the use of the drive motor(s), as it allows getting the best possible performances from said motor(s), in particular in terms of speed or acceleration conferred to the point of attachment and to the load, while complying at every time with the physical limits of said motor(s).

Indeed, it is understood that if a motor cannot reach the setpoint that is set thereto because said setpoint is too high with regard to the capabilities of said motor, therefore the real driving of the point of attachment will suffer from an insufficiency with respect to the desired driving, such that the movement of said point of attachment (and therefore the movement of the suspended load) which will be actually obtained will not correspond to the desired movement.

However, since by definition the execution setpoint is actually calculated exactly so as to (theoretically) obtain a regular and sway-free movement (desired movement), it will be understood that if, in practice, the drive motor does not execute correctly said execution setpoint, then the piloting system will not behave as desired, and that this may result in the occurrence of a sway and of some loss of control of the movements of the point of attachment and of the load.

By way of the subject matter described herein, it is possible herein to parametrize the C³ smoothing, and more particularly it is possible to parametrize the third-order filtering, and where appropriate make this parametrization of the C³ smoothing (respectively of the filtering) evolve over time, so that the execution setpoint, while promoting a rapid response of the piloting system, does not exceeds the actual capabilities of the drive motors in terms of maximum speed and maximum acceleration.

In this respect, it should be noted in particular that on the one hand the maximum acceleration that can be conferred to the point of attachment (trolley) depends directly on the maximum acceleration capability of the drive motors which serve to displace said point of attachment, and that on the other hand, because of the dynamics physical laws, a mathematical relationship exists between the acceleration of the point of attachment (acceleration of the trolley) and the third derivative of the speed of the suspended load.

Consequently, when the raw piloting setpoint (speed setpoint of the suspended load) expressed by the operator of the machine is C³ smoothed, according to the embodiments described herein, a flattening of the profile of the speed setpoint that will be applied to the drive motors is advantageously performed, that is to say that the evolution over time (and more particularly the rate of evolution per unit of time) of the value of the execution setpoint (value of the speed setpoint of the trolley) is flattened, according to an evolution profile which best reflects the desired piloting setpoint but which is also and especially compliant with the capability of the motors to provide a response which at every time matches said execution setpoint.

In this manner, the execution setpoint is always “achievable” in practice, that is to say that said execution setpoint is intrinsically such that said real piloting system is always capable of actually “achieving” (reaching) said execution setpoint that is applied thereto, and therefore providing a real response which is in accordance with the behavior expected from said piloting system, and more particularly in accordance with the behavior expected from the trolley (such that said expected behavior is defined by the execution setpoint).

Thus, the execution setpoint does never consider the defective real piloting system.

More particularly, the proposed third-order filter simplifies the implementation of appropriate saturations, during the processing of the piloting setpoint, and therefore the implementation of “smart” dynamic limitations of the execution setpoint, which allow getting the best of the drive motors while guaranteeing a permanent, accurate and reliable control of the movements of the point of attachment and of the suspended load.

Finally, it should be noted that the control method according to the embodiments described herein advantageously allows piloting the lifting machine by an open-loop servo-control, simply by applying the execution setpoint (speed setpoint) to the concerned drive motor, without requiring any measurement of the actual sway (that is to say without being necessary to obtain a feedback on the real angle of the sway), which limits or reduces the number of sensors as well as the computing power necessary for piloting, and consequently reduces the complexity, the bulk, and the energy consumption of the piloting system.

### BRIEF DESCRIPTION OF THE DRAWINGS

Other objects, features and advantages of the subject matter described herein will appear in more details upon reading the following description, as well as with reference to the appended drawings, provided only for an illustrative and non-restrictive purpose, among which:

FIG. 1 illustrates, according to a schematic perspective view, the general arrangement of an example of a lifting machine piloted by a method according to an embodiment.

FIG. 2 illustrates, according to a schematic side view, the general principle of a pendulum mechanical model which underlies the method according to an embodiment.

FIG. 3 illustrates, in the form of a block diagram, the calculation of the pulsation applicable to the third-order filter as well as the preliminary saturation of the piloting setpoint, which precedes the third-order filtering according to an embodiment.

FIG. 4 illustrates, in the form of a block diagram, the principle of implementation of a processing step (b) according to an embodiment, and more particularly the detail of a third-order filter according to an embodiment.

FIG. 5 illustrates, according to a schematic top view, the correspondence between the Cartesian and cylindrical coordinate systems allowing expressing the piloting setpoints, then the execution setpoints, in appropriate reference systems according to an embodiment.

FIG. 6 illustrates, in the form of a block diagram, the implementation of the method according to an embodiment to control on the one hand an orientation motor (the “orientation” referring to the yaw gyration component, about an axis (ZZ′) called “orientation axis”) and on the other hand a distribution motor (the “distribution” referring to the outwardly or inwardly radial component relative to the orientation axis (ZZ′)), from a piloting setpoint expressed in cylindrical coordinates, comprising a radial component and an angular component according to an embodiment.

FIG. 7 schematically illustrates a filtered piloting setpoint obtained in response to a step-type raw piloting setpoint, as well as an execution setpoint which is determined from said filtered piloting setpoint, as illustrated in FIG. 6, by means of a conversion formula derived from the mechanical model of FIG. 2.

### DESCRIPTION

The subject matter described herein concerns a method for controlling the displacement of a load 1 suspended to a point of attachment H of a lifting machine 2.

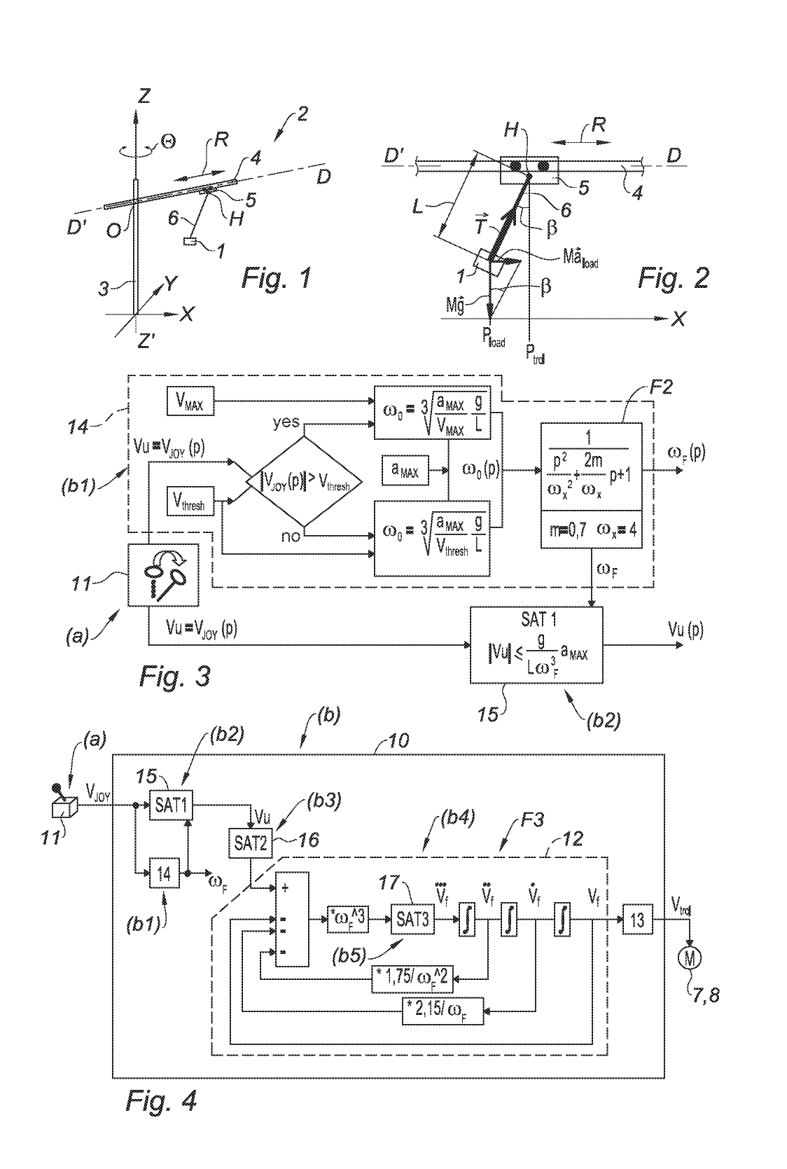

The lifting machine 2 is designed so as to be able to displace the point of attachment H, and consequently the suspended load 1, according to a yaw rotation component θ around a first vertical axis (ZZ′), called “orientation axis”, and/or according to a radial component R, corresponding to a movement called “distribution movement”, herein in translation along a second axis (DD′) called “distribution axis” secant to said orientation axis (ZZ′), as illustrated in FIGS. 1 and 2.

In particular, the lifting machine 2 may form a tower crane, whose mast 3 embodies the orientation axis (ZZ′), and whose jib 4 embodies the distribution axis (DD′), as illustrated in FIG. 1.

For the convenience of the description, such a configuration of a tower crane will be considered in the following, and more particularly a configuration of a tower crane with a horizontal jib 4, while understanding that it is perfectly possible to consider applying the principles described herein to other lifting machines, and in particular to mobile cranes or to a luffing boom crane.

The intersection of the distribution axis (DD′) and the orientation axis (ZZ′) will be noted O.

Preferably, the point of attachment H is formed by a trolley 5, which might advantageously be guided in translation along the distribution axis (DD′), along the jib 4.

For convenience, the trolley 5 may be assimilated to the point of attachment H in the following.

The orientation movement θ, and, respectively, the distribution movement R, and more particularly the drive movement of the trolley 5 in translation R along the jib 4, may be ensured by any appropriate drive motor 7, 8, preferably electric, and more particularly by at least one (electric) orientation motor 8 and, respectively, one (electric) distribution motor 7.

The load 1 is suspended to the point of attachment H by a suspension device 6, such as a suspension cable. Hence, for convenience, said suspension device will be assimilated to such a suspension cable 6 in the following.

Preferably, the suspended load 1 may also be displaced according to a vertical component, called “lifting component”, so as to be able to vary the height of the suspended load 1 relative to the ground.

Preferably, it will be possible for this purpose to make the length L of the suspension cable 6 vary, typically by means of a winch driven by a lifting motor (preferably electric), so as to be able to modify the distance of the suspended load 1 to the point of attachment H, and therefore either make the load 1 rise by shortening the length L (by winding the suspension cable 6), or on the contrary make said load 1 descend by extending said length L (by unwinding the suspension cable 6).

For convenience, it will be possible to refer by a “piloting system” to the assembly allowing ensuring the moving and the control of the displacement of the suspended load 1, said assembly typically comprising the module(s) (calculators) 10, 12, 13, 14, 15, 16, 17 allowing the implementation of the method according to the embodiments described herein, as well as the drive motor(s) 7, 8 (actuators), and where appropriate the movable members (effectors) of the machine driven by said drive motors 7, 8; said movable members will correspond herein on the one hand to the mast 3 and to the jib 4, yaw-orientable according to the orientation movement 0, and on the other hand to the trolley 5 ensuring the distribution movement R along the jib 4.

According to an embodiment, the method comprises a piloting setpoint acquisition step (a) during which a setpoint called the “piloting setpoint” Vᵤ is acquired and which is representative of a displacement speed V_{load} that the operator of the lifting machine 2 wishes to confer on the suspended load 1.

Afterwards, the method according to an embodiment comprises a processing step (b) during which a setpoint called the “execution setpoint” Vₜᵣₒₗ, which is intended to be applied to at least one drive motor 7, 8 in order to displace the suspended load 1, and, more particularly, in order to displace the trolley 5 to which said load 1 is suspended is elaborated, from said piloting setpoint Vᵤ, herein by means of a processing module 10.

It will be noted that, advantageously, the method allows performing a servo-control of speed, rather than trajectory, and more particularly a servo-control of the speed of the trolley 5, from a speed setpoint Vᵤ which corresponds to the speed desired for the suspended load 1.

Hence, in this respect, the execution setpoint Vₜᵣₒₗ will preferably express the speed setpoint that the point of attachment H must reach (that is to say the speed setpoint that the trolley 5 should reach).

In other words, the method preferably comprises a step (a) during which the operator (freely) defines and (intentionally) expresses a piloting setpoint in the form of a speed setpoint that he wishes the suspended load 1 to follow, then a processing step (b) during which said piloting setpoint (speed setpoint of the suspended load) is processed, herein more particularly filtered by a third-order filter, so as to be converted into a corresponding speed setpoint of the trolley 5, forming the (speed) execution setpoint Vₜᵣₒₗ which is applied to the adequate drive motor 7, 8.

Incidentally, it should be noted that the method provides the operator of the machine with a large freedom of action, since said operator can freely set, at any time, and according to the magnitude he chooses, the piloting setpoint (speed setpoint) Vᵤ that he wishes the load 1 to execute, and this without being for example forced to comply with a predetermined fixed trajectory.

Moreover, it will be noted that the method according to an embodiment is valid both for the piloting of the orientation movement θ as well as for the piloting of the distribution movement R, or for the piloting of any simultaneous combination of these two movements.

From a formal point of view, it will be noticed that it is advantageously possible to locate the position of the movable members, namely the point of attachment H/trolley 5 on the one hand, the suspended load 1 on the other hand, and express the movements of said movable members, either in a Cartesian reference system (O, X, Y, Z) associated to the base (considered to be fixed) of the lifting machine 2, or in a “polar”-type reference system (O, r, θ) using cylindrical, or even spherical, coordinates.

Conventionally, it is thus possible to note, in said Cartesian reference system:

Pₜᵣₒₗ^{X} and Pₜᵣₒₗ^{Y} the positions along X (first horizontal axis), respectively along Y (second horizontal axis, perpendicular to the first horizontal axis X), of the trolley 5 (the index “trol” referring to the trolley);

Vₜᵣₒₗ^{X} and Vₜᵣₒₗ^{Y} the speed components along X, respectively along Y, of said trolley 5;

P_{load}^{X} and P_{load}^{Y} the positions along X, respectively along Y, of the suspended load 1 (the index “load” referring to the suspended load 1);

V_{load}^{X} and V_{load}^{Y} the speed components along X, respectively along Y, of said suspended load 1, which correspond to the components of the (desired) speed of the suspended load 1, and therefore, in practice, to the components of the piloting setpoint Vᵤ.

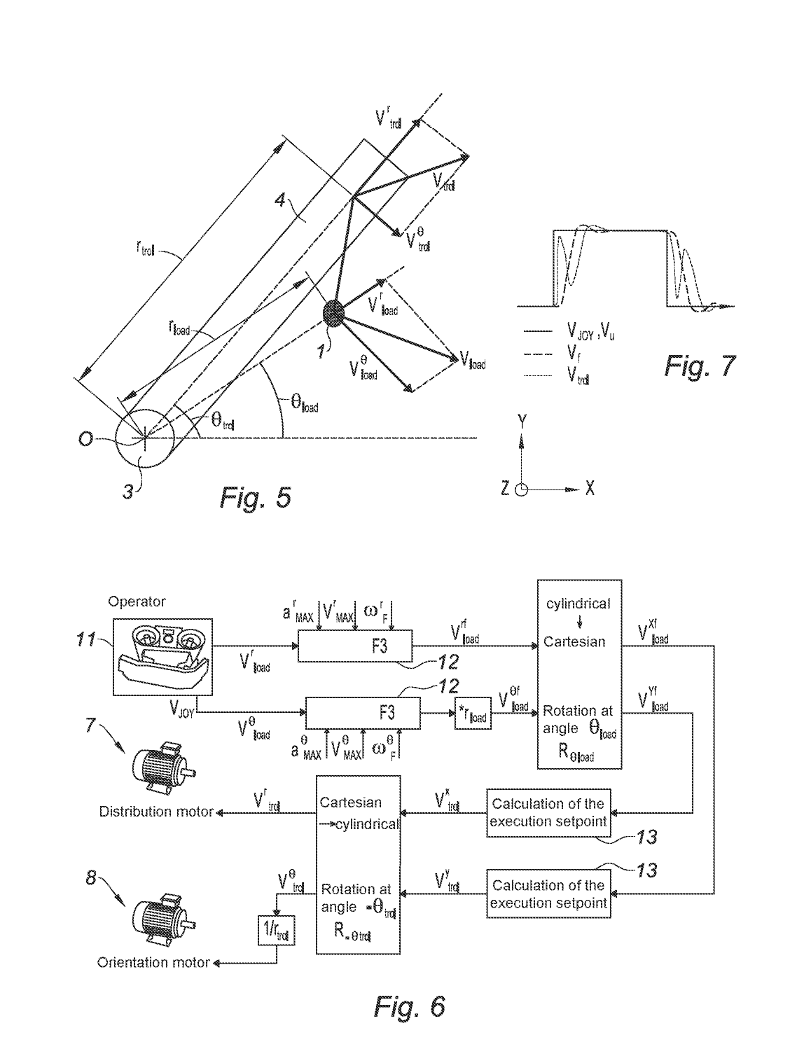

When using the cylindrical coordinates (r, θ), it will be more particularly possible to attach to each considered movable member a Frenet reference frame allowing expressing the radial component V^{r} (according to the distribution movement R) and the orthoradial component V^{θ} (according to the tangent to the orientation movement θ) of the speed of the considered movable member, as particular in illustrated in FIG. 5.

Thus, in said FIG. 5, as well as in FIG. 6, V_{load}^{r} and V_{load}^{θ} represent the radial and respectively orthoradial components of the speed vector V_{load} of the suspended load 1 (that is to say in practice the radial and orthoradial components of the speed piloting setpoint Vᵤ), whereas Vₜᵣₒₗ^{r and V}ₜᵣₒₗ^{θ} represent the radial and respectively orthoradial components of the speed vector Vₜᵣₒₗ of the trolley 5 (that is to say the radial and orthoradial components of the speed execution setpoint Vₜᵣₒₗ, which are applied respectively to the distribution motor 7 and to the orientation motor 8).

As illustrated in FIGS. 3, 4 and 6, the piloting setpoint Vᵤ may be provided by the operator of the machine by means of any appropriate control member 11.

Said control member 11 may be, in particular, in the form of a joystick, or of a set of controllers, which will enable the operator to express the orientation speed setpoint (yaw speed, orthoradial) V_{load}^{θ} and the distribution speed setpoint (radial speed) V_{load}^{r} that he wishes to impart to the suspended load 1.

For convenience of notation, the raw piloting setpoint Vᵤ, as expressed by the operator of the machine at the control member 11, that is to say the signal provided by the joystick at the input of the piloting system, will preferably be referenced as V_{JOY} in the aforementioned figures.

In order to better explain the embodiments herein, some elements of theoretical mechanics allowing modeling a pendular system will be now exposed, with reference to FIG. 2.

It should be noted that the explanation given herein in a plane, with reference to one single displacement dimension, according to the X axis, which is considered to be parallel to the jib 4 and to the distribution axis (DD′), remains valid in three dimensions.

According to the fundamental principle of dynamics (Newton's law), and while neglecting the possible external forces such as the wind:

M\vec{a}_{load}=\vec{T}+M\vec{g}

where

M represents the mass of the suspended load 1;

\vec{a}_{load} represents the acceleration of the suspended load 1 (which is herein considered to be carried by the horizontal direction X);

\vec{T} represents the tension of the suspension cable 6;

\vec{g} represents the gravity (the acceleration of gravity).

The equation hereinabove implies that the vector M\vec{a}_{load}−M\vec{g} is collinear with (parallel to) the vector \vec{T}. Therefore:

$$tan β = \frac{{Ma}_{load}}{Mg} = \frac{{a}_{load}}{g}$$

with β the angle (angle of the sway) that the suspension cable 6 forms with the vertical Z.

By making the assumption of small angles, it is also possible to write:

$$sin β \approx tan β = \frac{{P}_{trol} - {P}_{load}}{L}$$

with

Pₜᵣₒₗ the position (herein the X coordinate) of the trolley 5,

P_{load} the position (herein the X coordinate) of the load 1, and

L the length of the suspension cable 6.

The following relationship is deduced between the position Pₜᵣₒₗ of the trolley on the one hand, and the position P_{load} of the suspended load and the speed V_{load} of the load on the other hand:

$${P}_{trol} = {P}_{load} + \frac{L}{g} {a}_{load} = {P}_{load} + \frac{L}{g} \frac{d}{dt} {V}_{load}$$

and, by differentiating the expression hereinabove with respect to time, a second-order differential equation is obtained, called the “conversion formula”, which expresses the speed Vₜᵣₒₗ of the trolley 5 as a function of the speed V_{load} of the suspended load 1:

$${V}_{trol} = {V}_{load} + \frac{L}{g} \frac{{d}^{2}}{{dt}^{2}} {V}_{load}$$

which may also be expressed by the Laplace transform:

$${V}_{trol} ( p ) = ( 1 + \frac{L}{g} {p}^{2} ) {V}_{load}$$

In practice, using the conversion formula hereinabove, it is therefore possible to calculate the speed setpoint of the trolley Vₜᵣₒₗ, that is to say concretely the execution setpoint Vₜᵣₒₗ, from the value of the speed V_{load} that is desired to be conferred to the suspended load, that is to say from the piloting setpoint Vᵤ.

Nonetheless, it is also necessary to take into consideration the fact that, in the real piloting system, the trolley 5 has necessarily a finite (bounded) acceleration. This physical condition imposes that, from a mathematical point of view, the acceleration of the trolley, that is to say the time derivative of the speed of the trolley,

$${\dot{V}}_{trol} = \frac{d}{dt} {V}_{trol}$$

must on me one hand exist, and on the other hand be bounded (that is to say supplemented by a finite fixed value).

However, the calculation of the speed of the trolley (execution setpoint) Vₜᵣₒₗ according to the conversion formula hereinabove involves the second-time derivative

$${\ddot{V}}_{load} = \frac{{d}^{2}}{{dt}^{2}} {V}_{load}$$

of the speed of the suspended load (piloting speed) V_{load}.

With regards to this conversion formula, the acceleration of the trolley

$${\dot{V}}_{trol} = \frac{d}{dt} {V}_{trol}$$

may therefore be expressed in the form of a function of the third-time derivative

$${{V}^{⃛}}_{load} = \frac{d}{dt} {\ddot{V}}_{load} = \frac{{d}^{3}}{{dt}^{3}} {V}_{load}$$

of the speed of the load V_{load}.

It follows that the condition of existence and bounding of the acceleration of the trolley \dot{V}ₜᵣₒₗ imposes that the third-time derivative [symbol] _{load} of the speed of the load V_{load} exists and is bounded, that is to say that the speed of the suspended load V_{load} (and consequently the piloting setpoint Vᵤ which will serve to set said speed of the suspended load) is three times differentiable, and that its third derivative is continuous (and bounded).

In other words, it should be ensured that the piloting setpoint Vᵤ actually used to calculate (according to the conversion formula hereinabove) the execution setpoint Vₜᵣₒₗ is of class C³ (at every time, and at every circumstance), and this even though said piloting setpoint Vᵤ is initially expressed by the operator of the machine, and acquired substantially in real-time, in a raw form V_{JOY} which is likely to vary in an unpredictable manner over time, if the operator chooses to do so, and which therefore does not necessarily have these C³ smoothness properties.

This is particularly why, according to the embodiments described herein, the processing step (b) advantageously includes a C³ smoothing substep (b4) during which the piloting setpoint Vᵤ is processed so as to confer to said piloting setpoint Vᵤ properties of third differentiability with respect to time and continuity with respect to time, in order to generate, from said piloting setpoint Vᵤ, a filtered piloting setpoint V_{f} which is of class C³, then the execution setpoint Vₜᵣₒₗ is defined from said filtered piloting setpoint V_{f}.

According to a possible variant, the C³ smoothing may be performed using interpolation polynomials.

According to this variant, the piloting setpoint Vᵤ, and more particularly several ones and even all of the considered values among the succession of the different values taken by the piloting setpoint Vᵤ during a given time interval, are interpolated by means of a polynomial.

Said polynomial intrinsically has (at least) a C³ smoothness class, and therefore provides an approximation of the piloting setpoint which is both accurate and of class C³, in the form of a polynomial-type filtered piloting setpoint V_{f}.

Hence, such a polynomial provides a C³ flattening of the piloting setpoint.

Nonetheless, according to another particularly preferred variant simpler to implement than the variant by polynomial interpolation, during the C³ smoothing substep (b4), a third-order filter F3 is applied to the piloting setpoint Vᵤ, so as to C³ smooth said piloting setpoint, in order to generate the filtered piloting setpoint V_{f} which is of class C³.

In other words, the substep (b4) preferably constitutes a third-order filtering substep during which a third-order filter F3 is applied to the piloting setpoint Vᵤ in order to generate a filtered piloting setpoint V_{f} which is three times differentiable (and more exactly of smoothness class C³).

Preferably, the C³ smoothing, and more particularly the third-order filtering, is performed by means of a third-order filtering module 12, formed by an electronic or computer calculator.

The third-order filtering F3 may he expressed in the form of a transfer function:

$${V}_{f} ( p ) = F 3 \cdot {V}_{u} ( p ) = \frac{1}{\frac{{p}^{3}}{{ω}^{3}} + {c}_{2} \frac{{p}^{2}}{{ω}^{2}} + {c}_{1} \frac{p}{ω} + 1} {V}_{u} ( p )$$

with:

ω the pulsation of the third-order filter F3;

c₁, c₂ respectively the first-order and second-order coefficients, used by said third-order filter F3.

In the time domain, the third-order filter F3 translates into the following differential equation:

$${V}_{f} + \frac{{c}_{1}}{ω} {\dot{V}}_{f} + \frac{{c}_{2}}{{ω}^{2}} {\ddot{V}}_{f} + \frac{1}{{ω}^{3}} {{V}^{⃛}}_{f} = {V}_{u}$$

In order to optimize the third-order filter F3, values may be chosen where: c₁=2.15 and c₂=1.75, as shown in FIG. 4.

Indeed, these values allow optimizing the reactivity of the filter F3, by minimizing the response time at 5% (that is to say the time necessary to make the response converge towards a step-type setpoint with an error lower than 5% of the value of said step), while limiting the overshoot.

It should be noted that, according to an embodiment, it is possible to directly use the filtered piloting setpoint V_{f} as an execution setpoint Vₜᵣₒₗ applied to the drive motors 7, 8, that is to say that it is possible to set: Vₜᵣₒₗ=V_{f}.

Indeed, due to the C³ smoothing, obtained herein by the third-order filtering, the filtered piloting setpoint V_{f} is intrinsically defined, and more generally “flattened”, so as to progressively converge towards the piloting setpoint Vᵤ, without ever being “too stiff”.

In this manner, said filtered piloting setpoint V_{f}, C³ smoothed, is actually achievable, the drive motors 7, 8 being capable of following said filtered piloting setpoint V_{f}.

Thus, in the example illustrated in FIG. 7, where the operator of the machine applies a step-type piloting setpoint Vᵤ, it is noticed that the filtered piloting setpoint V_{f} actually evolves according to a slope which is more progressive than that of said step, and with no discontinuity.

Nonetheless, according to another particularly preferred variant, without having determined the filtered piloting setpoint V_{f}, the execution setpoint may be subsequently defined (and calculated) as follows, by applying the conversion formula mentioned hereinabove:

$${V}_{trol} = {V}_{f} + \frac{L}{g} {\ddot{V}}_{f}$$

with:

V_{f} the filtered piloting setpoint (C³ smoothed), herein coming more preferably from the third-order filter F3,

L the length of the suspension cable 6 which links the suspended load to the point of attachment, and

g gravity.

This conversion formula, simple and rapid to execute, has the advantage of being intrinsically an anti-sway function.

Thus, using he conversion formula hereinabove is advantageously equivalent to applying to the filtered piloting setpoint V_{f} an additional (anti-sway) function, which allows producing an execution setpoint Vₜᵣₒₗ which generates no sways

Indeed, the conversion formula hereinabove comes from a simplified pendulum model, in which the angle of the sway β is considered to be almost zero, that is to say that the suspended load 1 does not (or almost does not) sway relative to the trolley 5.

Advantageously, this means, in a reciprocal manner, that an execution setpoint Vₜᵣₒₗ elaborated from this model is such that, if said execution setpoint is actually executed faithfully by the drive motors 7, 8, and therefore by the trolley 5, said execution setpoint Vₜᵣₒₗ cannot cause a sway by itself.

FIG. 7 shows an execution setpoint Vₜᵣₒₗ accordingly obtained by applying the conversion formula to a filtered piloting setpoint V_{f} coming from a step-type piloting setpoint Vᵤ.

The conversion of the filtered setpoint V_{f} into an execution setpoint Vₜᵣₒₗ may be operated by any appropriate conversion module (calculator) 13, such as an electronic circuit or a computer-programmed module.

Moreover, it will be noted that the determination of the execution setpoint Vₜᵣₒₗ according to an embodiment may advantageously be carried out without being necessary to know, and a fortiori without being necessary to measure, the mass M of the suspended load 1, to the extent that this parameter (the mass M of the load 1) does not intervene in the formulas used during the processing step (b), and in particular does not intervene in the definition of the third-order filter F3 or in the aforementioned conversion formula.

Hence, it is possible to obviate the need for a measurement of the mass M of the suspended load 1 or for a processing of this mass parameter M, which, herein again, allows simplifying the structure of the lifting machine 2, and simplifying and accelerating the execution of the method.

Advantageously, the anti-sway effects intrinsically provided on the one hand by the C³ smoothing itself, and on the other hand by the use of a conversion formula which generates no sways, are combined together to offer an optimized servo-control of the movement of the suspended load 1, completely devoid of sway.

Considering the abilities of the method to generate an execution setpoint which does not cause any sway, it is possible, in a particularly preferred manner, to implement the open-loop servo-control according to the embodiments herein.

Thus, it is possible in particular to pilot the lifting machine 2, and more particularly the displacements of the trolley 5 (herein typically in orientation θ and in distribution R), by “blindly” or autonomously applying the execution setpoint (herein preferably a speed setpoint) Vₜᵣₒₗ to the drive motor(s) 7, 8, without providing for a servo-control which would aim to subsequently reduce the real sway which would possibly result from the application of this execution setpoint or which would result from external disturbances.

In particular, it will be thus possible to pilot the lifting machine 2 without having to use a measured or calculated feedback of the angle of the actual (real) sway of the suspended load 1, or a measured or calculated feedback of the angular speed of the actual sway of said suspended load 1 and preferably, without having to use a measured feedback of the actual (real) speed of the displacement of the point of attachment H.

By using the method according to an embodiment in open-loop, it is therefore possible to advantageously obtain an excellent control of the displacement of the suspended load 1, and more particularly to offer to the operator of the machine excellent possibilities of manual control of the displacement load, by means of a method which combines simplicity and rapidity of execution, while simplifying the structure of the lifting machine 2, and in particular while obviating the need for sensors intended to measure the sway.

That being so, the method described herein remains nonetheless compatible, in a variant, with a closed-loop servo-control, according to which the execution setpoint Vₜᵣₒₗ is firstly determined, in particular by making use of the third-order filtering, then said execution setpoint Vₜᵣₒₗ is subsequently applied to the drive motors 7, 8 while providing for a closed-loop servo-control (as described hereinabove) intended to actively reduce a possible sway, in case where such a sway would nevertheless appear, as being caused by disturbances external to the piloting system, such as wind gusts, for example.

Advantageously, according to such a variant, the determination of the execution setpoint Vₜᵣₒₗ according to an embodiment, with a C³ smoothing on the one hand, and with the use of the anti-sway conversion formula mentioned hereinabove on the other hand, will nonetheless allow generating an execution setpoint (speed setpoint of the trolley) Vₜᵣₒₗ which is already optimized, and which generates no sways (intrinsically), such that the sway compensation task assigned to the closed-loop of the servo-control will be greatly simplified (since it will consists only in reducing the possible sways caused by the sole disturbances external to the piloting system).

Moreover, it will be recalled that, by nature, the drive motors 7, 8 have limited (finite) capabilities in terms of speed, acceleration and torque.

Consequently, the execution setpoint Vₜᵣₒₗ is compatible with these capabilities, so as to enable the motors 7, 8 to actually execute said execution setpoint Vₜᵣₒₗ, and thus generate, as a result of the application of said execution setpoint Vₜᵣₒₗ to said motors 7, 8, sway-free movements of the trolley 5 and of the suspended load 1, which are in accordance with the movements that are expected with regards to said execution setpoint.

In other words, in one embodiment, it is may be beneficial to generate an execution setpoint Vₜᵣₒₗ which is achievable, that is to say coherent and compatible with the actual physical capabilities of the drive motors 7, 8, so as not to seek to solicit the piloting system beyond its capabilities, and thus so as to avoid a situation in which an insufficiency of a motor 7, 8 would lead the real movement to differ from the expected ideal movement, and would cause for example the occurrence or the accentuation of a sway.

In fine, with regards to the criteria of stability, of rapidity of convergence, and of compliance with the physical capabilities of the drive motors 7, 8, it is possible to consider that, generally, the filtered piloting setpoint (filtered speed setpoint) V_{f} should (simultaneously) address four cumulated constraints:
Constraint no. 1: the filtered speed setpoint V_{f}(t) must be three times differentiable, and more particularly of class C³;
Constraint no. 2: the filtered speed setpoint V_{f} should converge as rapid as possible towards the piloting setpoint Vᵤ (typically in response to a piloting setpoint Vᵤ forming a constant step);
Constraint no. 3: the acceleration of the trolley 5 should never exceed the intrinsic maximum acceleration capability of the corresponding drive motor 7. 8, that is to say that there is in permanence: |\dot{V}ₜᵣₒₗ|≦a_{MAX}, namely

$$\vert {\dot{V}}_{f} + \frac{L}{g} {{V}^{⃛}}_{f} \vert \leq {a}_{MAX}$$

where a_{MAX} is a value representative of the maximum acceleration that the drive motor 7, 8 can confer to the point of attachment H to which the load 1 is suspended (that is to say herein to the trolley 5);
Constraint no. 4: the speed setpoint of the trolley (execution setpoint) Vₜᵣₒₗ should never exceed the maximum speed that the drive motor 7, 8 can confer to the trolley 5, that is to say that there is in permanence: |Vₜᵣₒₗ|≦V_{MAX} namely:

$$\vert {V}_{f} + \frac{L}{g} {\ddot{V}}_{f} \vert \leq {V}_{MAX}$$

where V_{MAX} is a value representative of the maximum speed that the drive motor 7, 8 can confer to the point of attachment H to which the load 1 is suspended (that is to say herein to the trolley 5).

The C³ smoothing, and more particularly, the application of the third-order filter F3, allows addressing the constraint no. 1 (a setpoint three times differentiable, and more particularly of class C³).

It is possible to address the constraint no. 2 (rapid convergence) by properly choosing the coefficients c1, c2 of said third-order filter F3, as indicated hereinabove, and on the other hand, by adapting the pulsation ω of said third-order filter F3 depending on the circumstances, as will be detailed hereinafter.

Finally, it is possible to address the constraints no. 3 (acceleration limit) and no. 4 (speed limit), that is to say to ensure that the execution setpoint (speed setpoint of the trolley) Vₜᵣₒₗ is achievable, by applying appropriate saturation functions SAT1, SAT2, SAT3, which will be detailed in the following.

Thus, according to a preferred embodiment, during the C³ smoothing substep (b4), use may be made, to generate the filtered piloting setpoint V_{f}, of a parameter which is representative of the maximum acceleration a_{MAX} that the drive motor 7, 8 can confer to the point of attachment H to which the load 1 is suspended, so that the execution setpoint Vₜᵣₒₗ which results from said filtered piloting setpoint V_{f} depends on said maximum acceleration so as to be achievable by said drive motor 7, 8.

More particularly, said parameter chosen to be representative of the maximum acceleration a_{MAX} admissible by the drive motor 7, 8 may be the pulsation ω of the third-order filter F3, in the form of a pulsation called <<calculated pulsation>> ω₀ which will be determined in particular depending on said value of the maximum admissible acceleration a_{MAX}.

A relationship exists between the pulsation and the maximum admissible acceleration.

The acceleration of the trolley is

$${\dot{V}}_{trol} = {\dot{V}}_{f} + \frac{L}{g} {{V}_{f}}^{⃛} .$$

Assuming that a step-type setpoint Vᵤ is applied at a time t=0 (initial time), to a suspended load 1 at rest, that is to say to a system initially at equilibrium.

The system being initially at equilibrium, it is then possible to consider that the acceleration of the suspended load 1 is initially zero, that is to say that, at the time t=0: \dot{V}_{f}(0)≈0, because of the inertia whereas the acceleration \dot{V}ₜᵣₒₗ of the trolley 5 is maximum at this same time t=0, and is then

$$\frac{L}{g} {{V}^{⃛}}_{f} ( 0 ) = \frac{L}{g} {ω}^{3} {V}_{u} .$$

Hence, the constraint no. 3 (the acceleration limit) imposes:

$$\frac{L}{g} {ω}^{3} {V}_{u} \leq {a}_{MAX}$$

that is to say:

$$ω \leq {( \frac{{a}_{MAX} xg}{{V}_{u} xL} )}^{\frac{1}{3}}$$

Consequently, the processing step (b) may preferably comprise a substep (b1) of setting the pulsation of the third-order filter F3, during which the pulsation ω, ω₀ of said third-order filter F3 is calculated from a value a_{MAX} which is representative of the maximum acceleration that the drive motor 7, 8 can confer to the point of attachment H to which the load 1 is suspended.

Moreover, and to the extent that the equation hereinabove also involves, as a consequence of the constraint no. 3 (acceleration limit), a relationship between the pulsation ω and the speed setpoint Vᵤ, the processing step (b) will preferably comprise a substep (b1) of setting the pulsation ω of the third-order filter F3, during which the pulsation ω of the third-order filter, and more particularly the calculated pulsation ω₀, is adapted depending on the value of the piloting setpoint Vᵤ, V_{JOY} applied by the operator of the lifting machine at the considered time t.

More preferably, the value of the pulsation ω of the third-order filter F3 is modified depending on whether the piloting setpoint Vᵤ, V_{JOY} is lower than or on the contrary higher than a reference speed Vₜₕᵣₑₛₕ which is defined from the maximum speed value V_{MAX} that the drive motor 7, 8 can confer to the point of attachment H to which the load 1 is suspended.

In practice, the pulsation ω may be varied so as to increase said pulsation ω and thus use a pulsation considered to be high, called “high value” ω_{high}, and therefore a more reactive filter F3, when the absolute value of the piloting setpoint (that is to say the magnitude of the speed setpoint) Vᵤ, V_{JOY} is low with regards to the maximum admissible speed V_{MAX}, and on the contrary by decreasing said pulsation ω to a lower pulsation, called “low value” ω_{low}, when the absolute value of the piloting setpoint Vᵤ, V_{JOY} will increase to get close to the maximum admissible speed V_{MAX}.

In particular, when the speed setpoint corresponds to the maximum admissible speed: V_{U}=V_{MAX}, the constraint no. 3 (the acceleration limit) will actually impose:

$$ω \leq {( \frac{{a}_{MAX} xg}{{V}_{MAX} xL} )}^{\frac{1}{3}}$$

In practice, considering the foregoing, and as illustrated in FIG. 3, it is therefore possible for example to calculate the pulsation ω of the third-order filter F3, during the substep (b1) of setting the pulsation of the third-order filter, from a calculated pulsation ω₀ determined as follows:

set Vₜₕᵣₑₛₕ=k*V_{MAX}, with 0<k<1, for example k=0.5;

if Vᵤ≦Vₜₕᵣₑₛₕ, then define the calculated pulsation ω₀ as

$${ω}_{0} = {ω}_{high} = {( \frac{{a}_{MAX} xg}{{V}_{thresh} xL} )}^{\frac{1}{3}} ,$$

herein forming a high value;

if Vᵤ>Vₜₕᵣₑₛₕ, then define the calculated pulsation ω₀ as

$${ω}_{0} = {ω}_{low} = {( \frac{{a}_{MAX} xg}{{V}_{MAX} xL} )}^{\frac{1}{3}} ,$$

herein forming a low value, because V_{MAX}>Vₜₕᵣₑₛₕ such that ω_{low}<ω_{high};

with:

Vᵤ the piloting setpoint (herein equal to the raw piloting setpoint V_{JOY}),

k a chosen setting factor, comprised between 0 and 1,

L the length of the suspension cable 6 which links the suspended load 1 to the point of attachment H,

g gravity (the acceleration of gravity),

V_{MAX} an arbitrary (setting) value which is considered to be representative of the maximum speed that the drive motor 7, 8 can confer to the point of attachment H to which the load 1 is suspended; in practice, V_{MAX} will be arbitrarily chosen according to the characteristics of the lifting machine 2, of the expected load 1, and of the concerned drive motor 7, 8, and may for example be equal to the actual value of the maximum speed that the drive motor 7, 8 is actually capable, according to tests, of conferring to the trolley 5, or, preferably, be equal to a fraction (strictly lower than 100%, but non-zero) of this actual value of the maximum speed;

a_{MAX} an arbitrary (setting) value which is considered to be representative of the maximum acceleration that the drive motor 7, 8 can confer to the point of attachment H to which the load 1 is suspended; a_{MAX} may for example be equal to the actual value of the maximum acceleration of the motor, determined by tests, or, preferably, be equal to a fraction (strictly lower than 100%, but non-zero) of this actual value of the maximum acceleration.

The dual objective of this adaptation (in real-time) of the pulsation is to optimize the reactivity of the third-order filter F3 (constraint no. 2) by increasing said pulsation ω whenever possible, because the response time of the filter F3 is inversely proportional to said pulsation ω (with the coefficients c₁, c₂ chosen as indicated hereinabove, the response time at 5% is in the range of 4/ω) while complying with the constraint no. 3 relating to the non-exceedance of the maximum acceleration capability of the drive motor 7, 8, which sets an admissible upper limit for said pulsation ω.

Incidentally, it should be noted that regardless of the law taken on for determining the pulsation ω, the use of an adjustable pulsation allows dynamically setting the third-order filter F3, and integrating directly and intrinsically within said filter F3, in a particularly simple manner, a portion of the constraints relating in particular to the physical capabilities in terms of speed and acceleration of the drive motors 7, 8.

The adjustment of the pulsation ω of the third-order filter F3 may be achieved by any appropriate pulsation adjustment module 14, forming a calculator comprising for example an electronic circuit or a suitable computer program.

Moreover, in order to avoid destabilizing the third-order filter F3, in particular during the transitions between the high value ω_{high} and the low value ω_{low}, the (calculated) pulsation ω, ω₀ should be two times differentiable (with respect to time).

In this respect, it is desirable to smoothen the (calculated) pulsation ω, ω₀, in particular in order to guarantee that its evolutions over time, and in particular the aforementioned transitions high value ω_{high}/low value ω_{low}, are continuous and two times differentiable.

This is why, according to a preferred embodiment, during the substep (b1) of setting the pulsation ω of the third-order filter F3, during the determination of the pulsation ω, and more particularly to the calculated pulsation ω₀, a second-order filter F2 is applied, so that the third-order filter F3 uses as a pulsation ω a filtered calculated pulsation ω_{F}.

Said filtered calculated pulsation ω_{F} is accordingly preferably defined as:

$${ω}_{F} ( p ) = \frac{1}{1 + 2 m \frac{p}{{ω}_{X}} + \frac{{p}^{2}}{{ω}_{X}^{2}}} {ω}_{0} ( p )$$

with:

ω₀ the calculated pulsation (also called “target pulsation”), obtained as indicated hereinabove, before the second-order filtering F2,

ω_{X} the natural pulsation of the second-order filter F2, for example equal to 4 rad/s,

m the damping coefficient of the second-order filter F2, preferably equal to 0.7, but not limited thereto (this choice of value allowing obtaining a good compromise between a short response time and a limited overshoot of the second-order filter).

Moreover, it will be noticed that if the pulsation ω of the third-order filter F3, and more particularly the filtered pulsation ω=ω_{F} of said third-order filter F3, calculated as described hereinabove, varies continuously (that is to say regularly, without any discontinuity in the mathematical sense of the term) to converge towards the calculated target-pulsation ω₀, and more particularly varies so as to continuously switches from the high value ω_{high} to the low value ω_{low} or vice versa, therefore, in absolute terms, some situations may arise in which the inequality

$$\frac{L}{g} {ω}^{3} {V}_{u} \leq {a}_{MAX} ,$$

that is to say

$$ω \leq {( \frac{{a}_{MAX} xg}{{V}_{u} xL} )}^{\frac{1}{3}}$$

which results from the constraint no. 3 (limited acceleration capability) could be temporarily contravened.

Indeed, assuming for example an initial situation in which the operator of the machine barely solicits or not at all the displacement of the suspended load 1, so that the piloting (speed) setpoint Vᵤ is low, or even zero, such that it is lower than the reference speed: Vᵤ<Vₜₕᵣₑₛₕ, for example with Vᵤ=0 m/s.

The pulsation ω, ω_{F}, of the third-order filter F3 is then close to, or even equal to, its high value ω_{high}.

Assuming now that the operator of the machine suddenly applies a speed setpoint Vᵤ with a high magnitude, higher than the reference speed Vₜₕᵣₑₛₕ, and for example close to the maximum admissible speed: Vᵤ=V_{MAX} In practice, this amounts to applying to the piloting system a step according to which the operator makes the piloting setpoint Vᵤ switch almost instantaneously from its low, or even zero (typically 0 m/s), initial value to a high value, typically V_{MAX}.

Since the setpoint Vᵤ=V_{MAX} henceforth exceeds the reference speed Vₜₕᵣₑₛₕ, the automatic setting of the pulsation of the third-order filter, according to substep (b1), redefines the target pulsation value ω₀, and in this instance, it lowers it so as to set it to the low value: ω=ω_{low}.

However, because of the second-order filtering F2 which is applied to obtain the filtered pulsation ω_{F}, as actually used by the third-order filter F3, the transition of said filtered pulsation ω_{F} from its initial high value ω_{high} towards its (new) low target-value ω₀=ω_{low} is not instantaneous, but on the contrary relatively progressive, as said transition (in this instance, the decrease) of the pulsation, that is to say the convergence of the filtered pulsation ω_{F} towards the low value ω_{low}, may be operated slower than the change (herein the increase) of the piloting setpoint Vᵤ, that is to say slower than the convergence of the piloting setpoint Vᵤ towards its high value V_{MAX}.

Hence, it will be understood that, during the brief duration which is necessary to adapt the pulsation ω, ω_{F} of the third-order filter F3 to the new piloting setpoint Vᵤ, it is therefore possible to be temporarily in a situation in which a piloting setpoint close to its high value (Vᵤ being substantially equal to V_{MAX}) and a pulsation ω, ω_{F} also close to its high value ω_{high} exist together, as said pulsation “is slow” to decrease to reach its low value ω_{low}.

In such a case, the acceleration required for the trolley 5 would be provisionally substantially equal to

$$\frac{L}{g} {ω}_{high}^{3} {V}_{MAX} ,$$

and might thus temporarily exceed the maximum acceleration capability

$${a}_{MAX} = \frac{L}{g} {ω}_{low}^{3} {V}_{MAX}$$

of the motor 7, 8, since ω_{high}>ω_{low}.

This is particularly why, in order to avoid such a situation, and more particularly in order to guarantee that the inequality (set by the constraint no. 3) is permanently met

$$\vert {V}_{u} \vert \leq \frac{g}{L {ω}^{3}} {a}_{MAX} ,$$

the processing step (b) preferably comprises, according to an embodiment, a preliminary saturation substep (b2), during which a first saturation law SAT1 which is calculated according to the pulsation ω, ω_{F} of the third-order filter F3 (that is to say according to the instantaneous value of the pulsation ω, ω_{F} of the third-order filter at the considered time) is applied to the piloting setpoint Vᵤ, V_{JOY}.

As illustrated in particular in FIGS. 3 and 4, this first saturation law SAT1 may be implemented by an appropriate first saturation module 15, forming a calculator comprising for example an electronic circuit or a suitable computer program.

Preferably, the first saturation law SAT1 will be expressed by:

$$SAT 1 ( {V}_{u} ) = {V}_{u} if - \frac{g}{L {ω}_{F}^{3}} {a}_{MAX} \leq {V}_{u} \leq \frac{g}{L {ω}_{F}^{3}} {a}_{MAX}$$

$$SAT 1 ( {V}_{u} ) = - \frac{g}{L {ω}_{F}^{3}} {a}_{MAX} if {V}_{u} < - \frac{g}{L {ω}_{F}^{3}} {a}_{MAX}$$

$$SAT 1 ( {V}_{u} ) = + \frac{g}{L {ω}_{F}^{3}} {a}_{MAX} if {V}_{u} > \frac{g}{L {ω}_{F}^{3}} {a}_{MAX}$$

with

Vᵤ the piloting setpoint (herein equal to the raw piloting setpoint V_{JOY}),

ω_{F} the pulsation (and more particularly the filtered pulsation) of the third-order filter F3,

L the length of the suspension cable 6,

g gravity, and

a_{MAX} a value representative of the maximum acceleration that the drive motor 7, 8 can confer to the point of attachment H to which the load 1 is suspended (said maximum acceleration value being preferably defined as indicated hereinabove).

Preferably, as illustrated in FIGS. 3 and 4, the first saturation law SAT1 is applied to the raw (speed) setpoint V_{JOY}, before the third-order filtering F3, so as to form (at the output of the first saturation module 15) the piloting setpoint Vᵤ which is then sent towards the third-order filter F3.

Moreover, in some situations, when the length L of the suspension cable 6 is significant, the execution setpoint Vₜᵣₒₗ, and therefore the speed of the trolley 5, which is given by the conversion formula

$${V}_{trol} = {V}_{f} + \frac{L}{g} {\ddot{V}}_{f} ,$$

may exceed the maximum admissible speed V_{MAX}, that is to say contravene the constraint no. 4 (which sets: |Vₜᵣₒₗ|≦V_{MAX}), in particular if the piloting setpoint Vᵤ, and consequently the resulting filtered piloting setpoint V_{f}, undergoes rapid variations, proximate in time, and having a high magnitude.

The solution proposed herein limits the execution setpoint Vₜᵣₒₗ when said execution setpoint reaches a predefined admissible limit (typically +/− V_{MAX}), by saturating the piloting setpoint Vᵤ in an adequate manner.

The principle of recalculating the piloting setpoint Vᵤ when the execution setpoint (and therefore the speed of the trolley 5) Vₜᵣₒₗ reaches the maximum admissible value V_{MAX}, so that the absolute value of said execution setpoint |Vₜᵣₒₗ| remains (at the most) constant, or even decreases; in other words, the piloting setpoint Vᵤ is modified in order to cap the execution setpoint Vₜᵣₒₗ at its maximum admissible value V_{MAX}.

This is why the processing step (b) preferably comprises a secondary saturation substep (b3), which is intended to maintain constant or to make the execution setpoint (that is to say the speed setpoint of the point of attachment H) Vₜᵣₒₗ decrease when said execution setpoint Vₜᵣₒₗ substantially reaches the maximum speed V_{MAX} that the drive motor 7, 8 can confer to the point of attachment H (that is to say in practice to the trolley 5).

Mathematically, if it is desired to maintain the execution setpoint Vₜᵣₒₗ constant, this amounts to setting \dot{V}ₜᵣₒₗ=0, therefore

$$0 = {\dot{V}}_{trol} = {\dot{V}}_{f} + \frac{L}{g} {{V}^{⃛}}_{f} ,$$

and consequently

$${{V}^{⃛}}_{f} = - \frac{g}{L} {\dot{V}}_{f} .$$

Since, by the application of the third-order filter F3, there is:

$${V}_{f} + \frac{{c}_{1}}{{ω}_{F}} {\dot{V}}_{f} + \frac{{c}_{2}}{{ω}_{F}^{2}} {\ddot{V}}_{f} + \frac{1}{{ω}_{F}^{3}} {{V}^{⃛}}_{f} = {V}_{u}$$

$$therefore {{V}^{⃛}}_{f} = {ω}_{F}^{3} ( {V}_{u} - {V}_{f} - \frac{{c}_{1}}{{ω}_{F}} {\dot{V}}_{f} - \frac{{c}_{2}}{{ω}_{F}^{2}} {\ddot{V}}_{f} )$$

$$then {\dot{V}}_{trol} = 0 ⇔ {V}_{u} = {V}_{f} + \frac{{c}_{1}}{{ω}_{F}} {\dot{V}}_{f} + \frac{{c}_{2}}{{ω}_{F}^{2}} {\ddot{V}}_{f} - \frac{g}{L {ω}_{F}^{3}} {\dot{V}}_{f}$$

the second member of the last equation being noted, for convenience, E(t):

$$E ( t ) = {V}_{f} + \frac{{c}_{1}}{{ω}_{F}} {\dot{V}}_{f} + \frac{{c}_{2}}{{ω}_{F}^{2}} {\ddot{V}}_{f} - \frac{g}{L {ω}_{F}^{3}} {\dot{V}}_{f}$$

As indicated hereinabove, it is sought to maintain the execution setpoint Vₜᵣₒₗ constant or to make it decrease, when it reaches the maximum admissible speed Vₘₐₓ. Furthermore, in practice, if the piloting setpoint Vᵤ is low, this indicates in principle that a low trolley speed is sought, and therefore a low execution setpoint Vₜᵣₒₗ, that is to say that there is therefore no reason to keep said execution setpoint Vₜᵣₒₗ constant at its maximum value V_{MAX}, but rather make it decrease.

This is why, during the secondary saturation substep (b3), is therefore preferably applied to the piloting setpoint Vᵤ, according to an embodiment, a second saturation law SAT2 which is expressed by:

SAT2(Vᵤ)=MIN(E(t), Vᵤ) if Vₜᵣₒₗ>0, and

SAT2(Vᵤ)=MAX(E (t), Vᵤ) if Vₜᵣₒₗ<0,

with:

Vᵤ the piloting setpoint (which preferably comes from the first saturation module 15, after having undergone the first saturation law SAT1, as indicated in FIG. 4),

Vₜᵣₒₗ, the execution setpoint (speed of the trolley), herein estimated by the conversion formula:

$${V}_{trol} = {V}_{f} + \frac{L}{g} {\ddot{V}}_{f}$$

V_{f} the filtered piloting setpoint coming from the third-order filter F3,

and

$$E ( t ) = {V}_{f} + \frac{{c}_{1}}{{ω}_{F}} {\dot{V}}_{f} + \frac{{c}_{2}}{{ω}_{F}^{2}} {\ddot{V}}_{f} - \frac{g}{L {ω}_{F}^{3}} {\dot{V}}_{f}$$

with

c₁, c₂ respectively the first-order and second-order coefficients, used by the third-order filter F3 (typically, c₁=2.15 and c₂=1.75),

ω_{F} the pulsation (herein more particularly the filtered pulsation) of the third-order filter F3,

L the length of the suspension cable 6 which links the suspended load 1 to the point of attachment H,

g gravity.

As illustrated in particular in FIG. 4, this second saturation law SAT2 may be implemented by an appropriate second saturation module 16, forming a calculator comprising for example an electronic circuit or a suitable computer program.

It will be noted that, for the sake of stability, the activation and the deactivation of this second saturation law SAT2, in the vicinity of the maximum admissible speed V_{MAX}, may preferably be operated by a hysteresis switching.

More particularly, the second saturation law SAT2 being initially inactive, it will be activated when the execution setpoint Vₜᵣₒₗ will reach and exceed a triggering threshold, slightly higher than V_{MAX}, and for example set to 1.04*V_{MAX} (which reinforces the interest of choosing V_{MAX} slightly below the actual physical speed limit of the concerned drive motor 7, 8, typically between 95% and 98% of said physical limit), and be deactivated again when the execution setpoint Vₜᵣₒₗ will descend below an extinction threshold strictly lower than the triggering threshold, and being for example 1.01*V_{MAX}.

Moreover, even though the implementation of the first saturation law SAT1 described hereinabove can generally address the constraint no. 3 (acceleration of the trolley having to remain lower than the maximum admissible acceleration a_{MAX}), some very particular combinations of piloting setpoints may nevertheless contravene this constraint no. 3.

However, as indicated hereinabove, the application of an execution setpoint Vₜᵣₒₗ which would not comply with the physical limits, in particular the acceleration capability, of the drive motors 7, 8, might lead to the execution of a movement which is not compliant with the expected movement, and consequently the occurrence of a sway.

This is particularly why, in order to secure the movement of the suspended load 1 and to control and the accuracy of said movement, the processing step (b) preferably comprises, according to an embodiment, which may implemented as a complement of the first saturation law SAT1, a substep (b5) of saturation of the third derivative of the filtered piloting setpoint during which is applied to the third (time) derivative [symbol] of the filtered piloting setpoint V_{f} a third saturation law SAT3 whose saturation thresholds depend on the maximum acceleration a_{MAX} (typically as defined hereinabove) that the drive motor 7, 8 can confer to the point of attachment H to which the load 1 is suspended.

Advantageously, the implementation of this third saturation law SAT3 may add an additional precaution to that provided by the first saturation law SAT1, in order to optimize the safety of the open-loop control according to an embodiment.

More preferably, the third saturation law SAT3 may be expressed by:

$$SAT 3 ( {{V}^{⃛}}_{f} ) = {ω}_{F}^{3} x ( {V}_{u} - {V}_{f} - \frac{{c}_{1}}{{ω}_{F}} \dot{V} - \frac{{c}_{2}}{{ω}_{F}^{2}} \ddot{V} ) if$$

$$\frac{g}{L} ( - {\dot{V}}_{f} - {a}_{MAX} ) \leq {{V}^{⃛}}_{f} \leq \frac{g}{L} ( - {\dot{V}}_{f} + {a}_{MAX} ) , \\ SAT 3 ( {{V}^{⃛}}_{f} ) = \frac{g}{L} ( - {\dot{V}}_{f} - {a}_{MAX} ) if {{V}^{⃛}}_{f} < \frac{g}{L} ( - {\dot{V}}_{f} - {a}_{MAX} ) , and$$

$$SAT 3 ( {{V}^{⃛}}_{f} ) = \frac{g}{L} ( - {\dot{V}}_{f} + {a}_{MAX} ) if {{V}^{⃛}}_{f} > \frac{g}{L} ( - {\dot{V}}_{f} + {a}_{MAX} )$$

with:

V_{f} the filtered piloting setpoint coming from the third-order filter F3,

ω_{F} the pulsation (herein more particularly the filtered pulsation) of the third-order filter F3,

c₁, c₂ respectively the first-order and second-order coefficients, used by the third-order filter F3,

L the length of the suspension cable 6 which links the suspended load 1 to the point of attachment H,

g gravity, and

a_{MAX} a value representative of the maximum acceleration that the drive motor 7, 8 can confer to the point of attachment H to which the load 1 is suspended, said maximum acceleration value being typically defined as described hereinabove.

As illustrated in particular in FIG. 4, the third saturation law SAT3 may be implemented by an appropriate third saturation module 17, forming a calculator comprising for example an electronic circuit or a suitable computer program.

It will be noted that, advantageously, the reasoning and the equations proposed hereinabove can apply when considering a real situation, in three dimensions.

Indeed, if the crane is considered in a three-dimensional Cartesian reference system (X, Y, Z), where Z represents the vertical axis, herein coincident with the mast 3, it is still possible to state the Newton's law: M\vec{a}_{load}=\vec{T}+M\vec{g}

By making the assumption of small angles of sway, there is, in projection respectively on the X axis and on the Y axis:

$$\frac{{P}_{trol}^{X} - {P}_{load}^{X}}{L} = \frac{{a}_{X}}{g - {a}_{Z}} and \frac{{P}_{trol}^{Y} - {P}_{load}^{Y}}{L} = \frac{{a}_{Y}}{g - {a}_{Z}} ,$$

with a_{X}, a_{Y} and a_{Z} the respective X, Y and Z components of the acceleration of the suspended load 1.

According to a first possibility of implementation of the method according to an embodiment, it may be possible, in absolute terms, to keep, for the calculation of the execution setpoint Vₜᵣₒₗ, and more particularly for the calculation of the Cartesian components Vₜᵣₒₗ^{X} and Vₜᵣₒₗ^{Y} of said execution setpoint, expressions which involve the vertical acceleration a_{Z} of the suspended load 1, so as to be able to also compensate the potential effects of said vertical acceleration of the suspended load 1 on the sway generation.

Nonetheless, according to a second preferred possible implementation of the method according to an embodiment, it is possible in practice to consider, as a simplifying assumption, that the acceleration of the suspended load a_{Z} is negligible with regards to gravity g.

By simplifying the expressions hereinabove accordingly, it is found that:

$$\frac{{P}_{trol}^{X} - {P}_{load}^{X}}{L} \approx \frac{{a}_{X}}{g} and \frac{{P}_{trol}^{Y} - {P}_{load}^{Y}}{L} \approx \frac{{a}_{Y}}{g}$$

By subsequently differentiating these expressions with respect to time, and while considering, as a realistic simplification, that the speed of variation dL/dt of the length L of the suspension cable 6 is negligible, it may be obtained that:

$${V}_{trol}^{X} = {V}_{load}^{X} + \frac{L}{g} \frac{{d}^{2}}{{dt}^{2}} {V}_{load}^{X} and {V}_{trol}^{Y} = {V}_{load}^{Y} + \frac{L}{g} \frac{{d}^{2}}{{dt}^{2}} {V}_{load}^{Y}$$

Moreover, it should be noted that the method according to the embodiments described herein is particularly versatile because it can apply to any type of lifting machine 2, regardless of the configuration of said lifting machine 2, to the extent that in any case said method advantageously allows calculating the execution setpoint Vₜᵣₒₗ in a simple manner in a Cartesian reference system, regardless of the coordinate system (Cartesian, cylindrical or spherical), specific to the lifting machine 2, in which the piloting setpoint Vᵤ, V_{JOY} is firstly expressed when it is set by the operator of the machine, and in which the execution setpoint Vₜᵣₒₗ must then be expressed so that said execution setpoint could be appropriately applied to the concerned drive motors 7, 8.

Indeed, all it needs is to firstly convert into Cartesian coordinates, by means of a geometric transformation matrix (such as a rotation matrix), characteristic of the used lifting machine 2, and which will be noted Rₐ, the components of the piloting setpoint Vᵤ, V_{JOY} initially expressed in the coordinate system specific to the lifting machine 2, then calculate the execution setpoint Vₜᵣₒₗ in said Cartesian reference system, and finally convert again, by means of a reverse transformation matrix, that will be noted R_{-θ}, the Cartesian components of said execution setpoint Vₜᵣₒₗ into components expressed in the coordinate system specific to the lifting machine 2, applicable to the drive motors 7, 8 which respectively generate the displacement of said machine 2 (and more particularly of the trolley 5) according to each of said components. Thus, in the case of a lifting machine 2 formed a crane with a horizontal jib (tower crane with a horizontal jib), the most appropriate coordinate system to said machine 2 will be a cylindrical coordinate system in which the position of the considered object is located by a radius r (along the jib) and an azimuth angle θ (yaw angle about the orientation axis), as illustrated in FIGS. 1 and 5.

The piloting of the crane being performed in a very intuitive manner for the operator—in distribution (modification of the radius r) and in orientation (modification of the azimuth θ), each of the piloting setpoint Vᵤ, V_{JOY}, and of the execution setpoint Vₜᵣₒₗ, will therefore comprise a distribution component, intended to the distribution motor 7 (which allows acting on the radius) and an orientation component, intended to the orientation motor 8 (which allows acting on the azimuth).

The first conversion (of the piloting setpoint Vᵤ, V_{JOY}) from the cylindrical system towards the Cartesian system may be operated by means of a rotation matrix R_{θ}, whereas the second conversion (of the execution setpoint Vₜᵣₒₗ) from the Cartesian system toward the cylindrical system may be operated by means of a reverse rotation matrix R_{-θ}.

Similarly, in the case of a lifting machine 2 formed by a luffing boom crane, the most appropriate coordinate system will be the spherical coordinate system, in which the position of the trolley 5 is located (and piloted) by its azimuth (orientation of the luffing boom in yaw), its inclination (orientation of the luffing boom in pitch) and by its radius (distance of the trolley with respect to the hinged base of the luffing boom).

Herein again, the conversions towards and from the Cartesian system will be operated by appropriate geometric transformation matrices, so as to be able to manage the motor for driving the boom in azimuth (yaw), the motor for driving the boom in inclination (pitch), and the motor for driving in radius (translation along the boom).

In the case of a lifting machine 2 such as an overhead crane, designed to perform linear movements in translation along an axis (X), or along two axes perpendicular to each other (X and Y), the piloting setpoint may be expressed directly in a Cartesian reference system (X, Y), and will not therefore require any coordinates conversion.

In practice, and as illustrated in FIG. 6, the method according to an embodiment may therefore include the following operations successively:
the position of the suspended load 1 is given in a coordinate system adapted to the lifting machine 2, herein preferably in cylindrical coordinates: r_{load}, θ_{load};
the (raw) piloting setpoint V_{JOY} is expressed by the operator of the machine (via the joystick 11) in the form of a speed setpoint of the suspended load V_{load}, whose components correspond to the considered coordinate system; herein said speed setpoint of the suspended load V_{load}, comprises (is decomposed into) a desired radial component of the load speed V_{load}^{r} and a desired angular component of the load speed V_{load}^{θ};
the components of the speed setpoint of the suspended load V_{load} are accordingly C³ smoothed, and more particularly filtered for this purpose by the third-order filter F3;
thus, the first component of the speed setpoint of the suspended load, herein the desired radial component of the load speed V_{load}^{r}, is C³ smoothed, and more particularly filtered by the third-order filter F3 (filtering module 12), so as to obtain a filtered radial setpoint of the load speed V_{load}^{rf} (that is to say the first component of the filtered piloting setpoint V_{f});
similarly, the second component of the speed setpoint of the suspended load, herein the desired angular component of the load speed V_{load}^{θ}, is C₃ smoothed, and more particularly is filtered by the third-order filter F3 (filtering module 12), so as to obtain a filtered angular setpoint of the load speed, then it is multiplied by the radius r_{load}, which corresponds to the distance at which the suspended load 1 is located from the vertical axis of rotation (ZZ′), so as to obtain a filtered (orthoradial) tangential setpoint of the speed V_{load}^{θf} (that is to say the second component of the filtered piloting setpoint V_{f});
the filtered speed setpoint of the load (filtered piloting setpoint V_{f}), whose components, herein radial and tangential, are henceforth known, is therefore expressed in a Cartesian reference system by applying a geometric transformation matrix, herein the rotation matrix R_{θload} which corresponds to the yaw angular position θ_{load} of the suspended load 1: (V_{load}^{Xf},V_{load}^{Yf})=R_{θload}(V_{load}^{rf}, V_{load}^{θf});
on each axis X and Y of said Cartesian reference system, it is then possible to determine, thanks to the conversion formula (conversion module 13), the component corresponding to the execution setpoint (speed setpoint of the trolley) Vₜᵣₒₗ:

$${V}_{trol}^{X} = {V}_{load}^{Xf} + \frac{L}{g} {\ddot{V}}_{load}^{Xf} and {V}_{trol}^{Y} = {V}_{load}^{Yf} + \frac{L}{g} {\ddot{V}}_{load}^{Yf} ;$$

the execution setpoint (speed setpoint of the trolley) Vₜᵣₒₗ, available in Cartesian coordinates is then expressed in the coordinate system suitable to the lifting machine, in this instance in cylindrical coordinates, by applying a reverse geometric transformation matrix, herein a reverse rotation matrix R_{-θtrol} which corresponds to the yaw angular position θₜᵣₒₗ of the trolley 5: (Vₜᵣₒₗ^{r},Vₜᵣₒₗ^{θ})=R_{-θtrol}(Vₜᵣₒₗ^{X},Vₜᵣₒₗ^{Y});
the components of the execution setpoint Vₜᵣₒₗ are therefore applied each to their respective drive motor 7, 8; thus, the radial component Vₜᵣₒₗ^{r} of the execution setpoint Vₜᵣₒₗ is therefore applied to the distribution motor 7;
whereas the tangential component Vₜᵣₒₗ^{θ} of said execution setpoint Vₜᵣₒₗ is converted into an angular setpoint of the trolley speed, by multiplication by 1/rₜᵣₒₗ, where rₜᵣₒₗ represents the distance of the trolley 5 to the vertical axis of rotation (ZZ′), then applied to the orientation (yaw gyration) motor 8.

Moreover, it will be noted that the cylindrical coordinates of the trolley 5 (point of attachment H) may be known easily (in real-time), for example on the one hand by means of an angular position sensor which informs on the angular yaw angular position of the jib 4 with respect to the mast 3, that is to say the yaw angular position θₜᵣₒₗ of the trolley 5, and on the other hand by means of a position sensor, for example associated to the distribution drive motor 7, which allows knowing the position of the trolley 5 (in translation) along the jib 4, and consequently the radial distance rₜᵣₒₗ at which said trolley 5 is located from the vertical axis of rotation (ZZ′).

Similarly, the length L of the suspension cable 6 may be known in real-time by means of a sensor measuring the absolute rotation of the winch or of the lifting motor which generates the winding of said suspension cable 6.

Both the yaw angular position θ_{load} of the suspended load 1 and the (radial) distance r_{load} of said suspended load with respect to the vertical gyration axis (ZZ′) may be estimated by integration (over time) of the components of the filtered piloting setpoint V_{f}, since said components herein correspond respectively to the filtered radial speed of the load V_{load}^{rf} and to the filtered angular speed of the load V_{load}^{θf}.

Thus, more particularly, it is possible to assess an estimated radial position r_{load}_{_}ₑₛₜᵢₘ of the suspended load 1 as: r_{load estim}(t)=∫₀^{t} V_{load}^{rf}dt+r_{load}(0)

In this respect, it will be noted that, when the lifting machine 2, and more particularly the suspended load 1, is at rest, so that said suspended load 1 lies substantially vertically above the trolley 5, the yaw angular position and the distance to the gyration axis of the suspended load 1 are respectively identical to the yaw angular position and to the distance to the gyration axis of the trolley 5, which are in turn measured as indicated hereinabove.

Therefore, it is possible to set as an initial condition (and therefore as a calibration parameter) of the aforementioned integral calculation: r_{load}(0)=rₜᵣₒₗ(0), where <<0>> corresponds to an initial time when the system is at rest.

Where appropriate, in order to improve the accuracy of the estimation of the radial position of the suspended load 1, it is possible to use an observer (observation matrix) involving an additional measurement of the radial position of the trolley 5.

Moreover, it will be noted that the C³ smoothing, and more particularly the third-order filtering F3, might be applied to one (single) characteristic movement of the lifting machine 2 (typically the gyration orientation movement or the translational distribution movement in the preferred example illustrated in FIGS. 1 and 6), that is to say to only one of the components of the piloting setpoint Vᵤ, V_{JOY}, or to several ones of said characteristic movements (that is to say to several ones of said components), or, preferably, to all of said characteristic movements (that is to say to all the components of the piloting setpoint).

Moreover, the embodiments described herein concern as such the use of a C³ smoothing, and more particularly the use of a third-order filter F3, and where appropriate, the use of either of the saturation laws SAT1, SAT2, SAT3, in the determination of an execution setpoint Vₜᵣₒₗ intended to be applied to a drive motor 7, 8 allowing displacing a suspended load 1 to a lifting machine 2, according to either one of the arrangements described in the foregoing.

In this respect, it will be noted that the embodiments described herein cover as such the implementation of a C³ smoothing, and more particularly the implementation of the third-order filter F3, respectively of all or part of the saturation laws, regardless of the type of calculation used to subsequently determine the components of the execution setpoint Vₜᵣₒₗ.

The embodiments described herein also concern a control box for a lifting machine, comprising either of the modules (that is to say electronic and/or computer calculators) for C³ smoothing/third-order filtering 12, conversion 13, pulsation adjustment 14, or saturation 15, 16, 17 described hereinabove, as well as a lifting machine 2 equipped with such a control box. The control box may include, for example, a computer processor, a computer readable storage medium and a communication module configured to receive information and transmit information. The computer readable storage medium is configured to store program instructions to be executed by the computer processor, and when executed, cause the processor to carry out the methods described herein. The control box may be operatively connected to the piloting system. For example, the communication module may be configured to receive information, such as information input by user operation of a crane control device, such as a joystick, and may be configured to transmit information, for example, to various crane components. Accordingly, the control box may control operation of crane components in accordance with the methods described herein.

Finally, the embodiments described herein are of course in no way limited to the sole variants described, those skilled in the art being in particular capable of freely isolating or combining together either of the features described in the foregoing, or substituting them with equivalents.

1-14. (canceled)

15. A method for controlling displacement of a load suspended to a point of attachment of a lifting machine, said method comprising a piloting setpoint acquisition step, during which a piloting setpoint (Vᵤ) is acquired and which is representative of a displacement speed (V_{load}) that the operator of the lifting machine wishes to confer on the suspended load, and a processing step during which an execution setpoint (Vₜᵣₒₗ), which is intended to be applied to at least one drive motor in order to displace the suspended load (1), is elaborated from said piloting setpoint (Vᵤ), the method being characterized in that the processing step includes a C³ smoothing substep during which the piloting setpoint (Vᵤ) is processed so as to confer to said piloting setpoint (Vᵤ) properties of third differentiability with respect to time and continuity with respect to time, in order to generate, from said piloting setpoint (Vᵤ), a filtered piloting setpoint (V_{f}) which is of class C³, then the execution setpoint (Vₜᵣₒₗ) is defined from said filtered piloting setpoint (V_{f}).

16. The method according to claim 15, characterized in that the execution setpoint (Vₜᵣₒₗ) expresses the speed setpoint that the point of attachment reaches, and is defined as follows:
$${V}_{trol} = {V}_{f} + \frac{L}{g} {\ddot{V}}_{f}$$
with:
V_{f} the filtered piloting setpoint,
L the length of a suspension cable which links the suspended load to the point of attachment, and
g gravity.

17. The method according to claim 15, characterized in that, during the C³ smoothing substep, use is made, to generate the filtered piloting setpoint (V_{f}), of a parameter (ω, ω₀) which is representative of the maximum acceleration (a_{MAX}) that the drive motor can confer to the point of attachment to which the load is suspended, so that the execution setpoint (Vₜᵣₒₗ) which results from said filtered piloting setpoint (V_{f}) depends on said maximum acceleration so as to be achievable by said drive motor.

18. The method according to claim 15, characterized in that, during the C³ smoothing substep, a third-order filter is applied to the piloting setpoint (Vᵤ) in order to generate the filtered piloting setpoint (V_{f}) which is of class C³.

19. The method according to claim 18, characterized in that the processing step comprises a substep of setting a pulsation of the third-order filter, during which the pulsation (ω, ω₀) of said third-order filter is calculated from a value (a_{MAX}) which is representative of the maximum acceleration that the drive motor can confer to the point of attachment to which the load is suspended

20. The method according to claim 18, characterized in that the processing step comprises a substep of setting the pulsation (ω, ω₀, ω_{F}) of the third-order filter, during which the pulsation (ω, ω₀, ω_{F}) of the third-order filter is adapted according to the value of the piloting setpoint (Vᵤ) applied by the operator of the lifting machine at the considered time, and more preferably the value of the pulsation (ω, ω₀, ω_{F}) of the third-order filter is modified depending on whether the piloting setpoint (Vᵤ) is lower or on the contrary higher than a reference speed (Vₜₕᵣₑₛₕ) which is defined from the maximum speed value (V_{MAX}) that the drive motor can confer to the point of attachment to which the load is suspended.

21. The method according to claim 18, characterized in that the processing step comprises a substep of setting a pulsation of the third-order filter, during which the pulsation (ω) of the third-order filter is calculated from a calculated pulsation (ω₀) determined as follows:
Vₜₕᵣₑₛₕ=k*V_{MAX}, with 0<k<1;
if Vᵤ≦Vₜₕᵣₑₛₕ, then define the calculated pulsation (ω₀) to a high value of
$${ω}_{0} = {ω}_{high} = {( \frac{{a}_{MAX} xg}{{V}_{thresh} xL} )}^{\frac{1}{3}}$$
if Vᵤ22 Vₜₕᵣₑₛₕ, then define the calculated pulsation (ω₀) to a low value of
$${ω}_{0} = {ω}_{low} = {( \frac{{a}_{MAX} xg}{{V}_{MAX} xL} )}^{\frac{1}{3}}$$
with:
Vᵤ the piloting setpoint,
L the length of the suspension cable which links the suspended load to the point of attachment,
g gravity,
V_{MAX} a value representative of the maximum speed that the drive motor can confer to the point of attachment to which the load is suspended, and
a_{MAX} is a value representative of the maximum acceleration that the drive motor can confer to the point of attachment to which the load is suspended.

22. The method according to claim 21, characterized in that, during the substep of setting the pulsation of the third-order filter, a second-order filter is applied to the calculated value (ω, ω₀), so that the third-order filter uses a filtered calculated pulsation (ω_{F}), said filtered calculated pulsation (ω_{F}) thus being preferably defined as:
$${ω}_{F} ( p ) = \frac{1}{1 + 2 m \frac{p}{{ω}_{X}} + \frac{{p}^{2}}{{ω}_{X}^{2}}} {ω}_{0} ( p )$$
with:
ω₀ the calculated pulsation, before the second-order filtering,
ω_{X} the natural pulsation of the second-order filter, and
m the damping coefficient of the second-order filter.

23. The method according to claim 18, characterized in that the processing step comprises a preliminary saturation substep, during which a first saturation law is applied to the piloting setpoint (Vᵤ) and which is calculated according to the pulsation (ω, ω_{F}) of the third-order filter.

24. The method according to claim 23, characterized in that the first saturation law is expressed by:
$$SAT 1 ( {V}_{u} ) = {V}_{u} if - \frac{g}{L {ω}_{F}^{3}} {a}_{MAX} \leq {V}_{u} \leq \frac{g}{L {ω}_{F}^{3}} {a}_{MAX}$$
$$SAT 1 ( {V}_{u} ) = - \frac{g}{L {ω}_{F}^{3}} {a}_{MAX} if {V}_{u} < - \frac{g}{L {ω}_{F}^{3}} {a}_{MAX}$$
$$SAT 1 ( {V}_{u} ) = + \frac{g}{L {ω}_{F}^{3}} {a}_{MAX} if {V}_{u} > \frac{g}{L {ω}_{F}^{3}} {a}_{MAX}$$
with
Vᵤ the piloting setpoint,
ω_{F} the pulsation of the third-order filter,
L the length of the suspension cable which links the suspended load to the point of attachment,
g gravity, and
a_{MAX} a value representative of the maximum acceleration that the drive motor can confer to the point of attachment to which the load is suspended.

25. The method according to claim 15, characterized in that the processing step comprises a secondary saturation substep, which is intended to maintain constant or to make the execution setpoint (Vₜᵣₒₗ) decrease when said execution setpoint substantially reaches the maximum speed (V_{MAX}) that the drive motor can confer to the point of attachment

26. The method according to claim 25, characterized in that, during the secondary saturation substep, a second saturation law is applied to the piloting setpoint (Vᵤ) and is expressed by:
SAT2(Vᵤ)=MIN(E(t), Vᵤ) if Vₜᵣₒₗ>0, and
SAT2(Vᵤ)=MAX(E(t), Vᵤ) if Vₜᵣₒₗ<0, with:
Vᵤ the piloting setpoint
Vₜᵣₒₗ the execution setpoint, estimated by:
$${V}_{trol} = {V}_{f} + \frac{L}{g} {\ddot{V}}_{f}$$
V_{f} the filtered piloting setpoint coming from the third-order filter (F3), and
$$E ( t ) = {V}_{f} + \frac{{c}_{1}}{{ω}_{F}} {\dot{V}}_{f} + \frac{{c}_{2}}{{ω}_{F}^{2}} {\ddot{V}}_{f} - \frac{g}{L {ω}_{F}^{3}} {\dot{V}}_{f}$$
with
c₁, c₂ respectively the first-order and second-order coefficients, used by the third-order filter,
ω_{f}, the pulsation of the third-order filter,
L the length of the suspension cable which links the suspended load to the point of attachment, and
g gravity.

27. method according claim 15, characterized in that the processing step comprises a substep of saturation of the third derivative of the filtered piloting setpoint during which a third saturation law is applied to the third derivative ( [symbol] ) of the filtered piloting setpoint (V_{f}) and whose saturation thresholds depend on the maximum acceleration (a_{MAX}) that the drive motor (7, 8) can confer to the point of attachment (H) of the suspended load (1).

28. The method according to claim 13, characterized in that the third saturation law is expressed by:
$$SAT 3 ( {{V}^{⃛}}_{f} ) = {ω}_{F}^{3} x ( {V}_{u} - {V}_{f} - \frac{{c}_{1}}{{ω}_{F}} \dot{V} - \frac{{c}_{2}}{{ω}_{F}^{2}} \ddot{V} if \\ \frac{g}{L} ( - {\dot{V}}_{f} - {a}_{MAX} ) \leq {{V}^{⃛}}_{f} \leq \frac{g}{L} ( - {\dot{V}}_{f} + {a}_{MAX} ) , \\ SAT 3 ( {{V}^{⃛}}_{f} ) = \frac{g}{L} ( - {\dot{V}}_{f} - {a}_{MAX} ) if {{V}^{⃛}}_{f} \frac{g}{L} ( - {\dot{V}}_{f} - {a}_{MAX} ) , \\ and \\ SAT 3 ( {{V}^{⃛}}_{f} ) = \frac{g}{L} ( - {\dot{V}}_{f} + {a}_{MAX} ) if {{V}^{⃛}}_{f} > \frac{g}{L} ( - {\dot{V}}_{f} + {a}_{MAX} )$$
with
V_{f} the filtered piloting setpoint coming from the third-order filter,
ω_{F} the pulsation of the third-order filter,
c₁, c₂ respectively the first-order and second-order coefficients, used by the third-order filter,
L the length of the suspension cable which links the suspended load to the point of attachment,
g gravity, and
a_{MAX} a value representative of the maximum acceleration that the drive motor can confer to the point of attachment to which the load is suspended.
